(19) United States
(12) Patent Application Publication
(10) Pub. No.: US 2014/0278817 A1
(43) Pub. Date: Sep. 18, 2014

(54) Systems and Methods for Managing Energy Generation and Procurement

(71) Applicant: Open Access Technology International, Inc., Minneapolis, MN (US)

(72) Inventors: Ilya William Slutsker, Plymouth, MN (US); Sasan Mokhtari, Eden Prairie, MN (US); Guillermo Irisarri, Plymouth, MN (US); Tan Trong Dang, Plymouth, MN (US)

(73) Assignee: Open Access Technology International, Inc., Minneapolis, MN (US)

(21) Appl. No.: 14/216,148

(22) Filed: Mar. 17, 2014

Related U.S. Application Data
(60) Provisional application No. 61/791,534, filed on Mar. 15, 2013.

(51) Int. Cl. G06Q 10/06

(52) U.S. Cl. CPC G06Q 10/0637
USPC 705/7.36

(57) ABSTRACT

A system and method for optimally assigning energy generation and procurement resources whereby information needed to calculate an optimal-cost generation plan is obtained by a database connected to the calculation module. Data from the database is automatically checked for errors, formulated into an objective function representing hypothetical generation plans, and framed within mathematical constraints by the module. Generation plans are automatically delivered in customizable formats, and functionality allowing for considerations beyond cost can be implemented. Functionality to automate the method based for periodic or event-based operation is also included. Further calculations based on hypothetical values are possible to determine how said hypothetical values would affect generation plans, or whether increasing generation-fleet output could result in added profits.

### CROSS-REFERENCE TO RELATED APPLICATIONS

This application claims priority to U.S. Provisional patent application No. 61/791,534 filed Mar. 15, 2013, the entire content of which is hereby incorporated by reference.

Applicant has other co-pending applications directed to the energy market, namely:

SYSTEMS AND METHODS FOR DEMAND RESPONSE AND DISTRIBUTED ENERGY RESOURCE MANAGEMENT, filed Feb. 9, 2011 and assigned application Ser. No. 13/024,158, the entire contents of which is hereby incorporated by reference.

AUTOMATION OF ENERGY TRADING, filed Dec. 30, 2011 and assigned application Ser. No. 13/140,248, the entire contents of which is hereby incorporated by reference.

CERTIFICATE INSTALLATION AND DELIVERY PROCESS, FOUR FACTOR AUTHENTICATION, AND APPLICATIONS UTILIZING SAME, filed Oct. 15, 2013 and assigned application Ser. No. 14/054,611, the entire contents of which is hereby incorporated by reference.

A renewable energy credit management system and method, filed Feb. 10, 2014 and assigned application Ser. No. 14/176,590, the entire contents of which is hereby incorporated by reference.

Systems and methods of determining optimal scheduling and dispatch of power resources, filed on Mar. 17, 2014 (Docket No. 017.2P-15315-US03), the entire contents of which is hereby incorporated by reference.

Systems and methods for tracing electrical energy of a load to a specific generator on a power grid, filed on Mar. 17, 2014 (Docket No. 017.2P-15493-US03), the entire contents of which is hereby incorporated by reference.

Systems and methods for trading electrical power, filed on Mar. 17, 2014 (Docket No. 017.2P-15565-US03), the entire contents of which is hereby incorporated by reference.

Systems and methods for managing conditional curtailment options, filed on Mar. 17, 2014 (Docket No. 017.2P-15571-US03), the entire contents of which is hereby incorporated by reference.

Systems and methods for tracking greenhouse gas emissions, filed on Mar. 17, 2014 (Docket No. 017.2P-15954-US02), the entire contents of which is hereby incorporated by reference.

Systems and methods for parameter estimation for use in determining value-at-risk, filed on Mar. 17, 2014 (Docket No. 017.2P-15955-US02), the entire contents of which is hereby incorporated by reference.

Systems and methods for managing transmission service reservations, filed on Mar. 17, 2014 (Docket No. 017.2P-15956-US02), the entire contents of which is hereby incorporated by reference.

Systems and methods for interfacing an electrical energy end user with a utility, filed on Mar. 17, 2014 (Docket No. 017.2P-15958-US02), the entire contents of which is hereby incorporated by reference.

Use of Demand Response (DR) and Distributed Energy Resources (DER) to mitigate the impact of Variable Energy Resources (VER) in Power System Operation, filed on Mar. 17, 2014 (Docket No. 017.2P-15959-US02), the entire contents of which is hereby incorporated by reference.

### STATEMENT REGARDING FEDERALLY SPONSORED RESEARCH

Not Applicable

### FIELD OF THE INVENTION

The present disclosure relates generally to electric power and, more particularly, to systems and methods of analyzing and determining optimal scheduling of various generation resources.

### BACKGROUND OF THE INVENTION

Prior to the development of the present disclosure, unit commitment of generation resources and real-time dispatch of generation were analyzed using spreadsheet-based calculations, heuristic methods, and approximation algorithms such as Lagrangian Relaxation, to calculate approximately efficient uses and dispatch of generation resources and products. Such earlier methods require such a high level of approximation and/or imprecise calculation methods that solutions achieved are not accurate enough and do not produce optimal results such as the minimization of operating costs. Some of the manual methods used to solve the problem equations were not streamlined with input-entering methods. As a result, gathering all required inputs for some calculations became too burdensome, as many inputs came from different sources, required preliminary calculations to obtain, or changed frequently. Further, although hypothetical (study mode) calculations were possible, but such manual collection and entering of inputs made performing these hypothetical calculations impractical. Hypothetical calculations are useful, inter alia, in making decisions relating to whether to purchase another generation provider's more economical energy, and thus their ease of use helps to develop informed business decisions.

All energy, whether generated or purchased from other generation owners, must be transmitted over available transmission channels in a way that falls within physical limitations and meets industry and regulatory standards. Prior to the development of the present disclosure, generation owners needed to compare generation and energy-purchase plans with multiple sources of available and committed transmission data. This added to complexity and prevented efficient selection of the most cost-effective generation/purchase plan.

Analysis of energy trading was performed by persons of ordinary skill in the art by comparing generation requirements to serve load with current generation forecasts, maximum available generation, and energy-purchase deals from other generation owners. The costs of increasing current generation and purchasing energy from numerous other generation owners were able to be compared, but no pre-existing system allows an integrated, customizable utilization of all generation resources, at a minimal cost, while satisfying scheduling and delivery constraints.

For example, if a generation owner discovered increased energy demand to be served or developed ambitions to generate the energy for the load another generation owner is currently serving, said generation owner could increase the output of the generation fleet. However, the generation owner was faced with an inaccurate and cumbersome method of developing a plan for said increased output. Such a plan requires knowledge not only of all the generation units with capability to increase output, but of the cost of increasing the output for each generating unit by specific amounts. The required parameters of these hypothetical specific increases, for all generation units, must then be compared to determine the most cost-effective method of increasing fleet generation to meet the new demand or requirements of said other load generation unit.

### BRIEF SUMMARY OF THE INVENTION

The present disclosure relates to systems and methods for considering a various multitude of input factors to calculate optimal solutions, here defined as the minimization of costs or the converse maximization of profit, over time in the generation and procurement of energy. These calculations may be subject to certain global system or individualized resource limitations. Functionalities in furtherance of calculating optimization include, but are not limited to, creating operating plans for generation utilization or evaluating the impacts of potential energy trade opportunities within a defined zone of generation assets.

The current embodiments address the problems inherent in the prior art with a new system for determining optimal-cost solutions. The system automatically collects, transfers, and stores all inputs and outputs needed for determining a solution, and automatically includes some inputs that were not previously considered either because of difficulty in procurement or because they are time consuming to obtain. The system provides functionality for solutions to be obtained automatically at set intervals, or upon the occurrence of certain events. The system ensures specificity to a generation owner's situation by allowing customization of inputs and algorithms to take non-cost factors into account when determining solutions. Finally, the system provides functionality for the customizable presentation of analysis comparing generation and trading, allowing for more complete results.

### BRIEF DESCRIPTION OF DRAWINGS

FIG. 1 is a block diagram illustrating one embodiment in which cost-optimal generation plans are determined and reported from a list of inputs automatically retrieved from a database.

FIG. 2 is a block diagram illustrating an example set of inputs that may be read from a database in a determination plan similar to that exemplified in FIG. 1.

FIG. 3 is a block diagram illustrating an example set of constraints that may be applied to inputs similar to those exemplified in FIG. 1.

FIG. 4 is a block diagram illustrating one embodiment in which a generation owner is able to relax limitations placed on input data and the objective function used in calculation.

FIG. 5 is a block diagram illustrating one embodiment in which cost-optimal generation plans for hypothetical amounts of additional generation are determined and reported from a list of inputs automatically retrieved from a database.

FIG. 6 is a block diagram illustrating a computer system that may be utilized in the performance of the disclosed methods and processes.

### DETAILED DESCRIPTION OF THE INVENTION

Turning now to the drawings in greater detail, it will be seen that FIG. 1 is a simplified block diagram of one possible embodiment of a module of the invention, wherein cost-optimal generation plans are calculated from Inputs 104 automatically retrieved from Database 102. The module automatically selects which Inputs 104 are relevant to calculating the generation plan and retrieves them (step 106), either by accessing them in Database 102 or copying/transferring them from Database 102 to a storage medium to which the module has more convenient access. The module then performs a check on the Inputs 104 (step 108) to ensure that all Inputs 104 fall within feasible values. If the Inputs 104 are not valid the module will proceed to report the improper data (step 110). In this embodiment the data error is reported to a user (step 110) through a user interface, but in an embodiment not initiated by a user the data error could be reported to another part of a larger program or system in which the module is integrated. Said larger program or system may contain a set of rules that determines automatic responses to said data error or may enter it into a log for further reference.

If step 108 determines that the Inputs 104 are valid, the module will formulate the objective function (step 112) by feeding the applicable Inputs 104 into an equation representing the potential output plans of all generation units. The set of all possible variations of this objective function thus represents all possible energy-generation plans based on Inputs 104. Optimal cost may be found by minimizing the objective function to minimize cost (primal sub-problem), or maximizing function to maximize profit (dual sub-problem), depending on the terms of the objective function. This objective function is then sent to the solver with equations representing constraints to be applied to the objective function (step 114). These constraints, expressed as equations, are limitations to be applied to the variables in the objective function and set boundaries on what forms of the objective function and its variables (and thus, what solutions) are acceptable. Examples of constraints are shown in FIG. 2.

In some embodiments the module will have the ability to translate all equations from complex form to applicable program language. In preferred embodiments the constraint equations are permanently converted to the applicable program language and stored as such in the code of the module. The particular language into which the equations are converted is not important to this embodiment, but the program language chosen must be understood by all programs and modules required to implement the equations. The solver may be functionality internal to the module or a separate program to which the equation data must be sent. In some embodiments the solver may be a third-party API.

After equations are sent to the solver (step 114) the module queries the solver for the solution (step 116). In some embodiments the module may repeatedly query the solver, repeating step 116, if necessitated by the solver failing to calculate the solution before the first query. The solver in this embodiment sends information that the problem is not solvable if the objective function cannot be minimized/maximized, as applicable, to optimize costs while bound by all constraints. If the module receives such information an equation error is reported to user (step 118). In other non-user-initiated embodiments the equation error could be reported to another part of a larger program or system in which the module is integrated. Said larger program or system may contain a set of rules that determines automatic responses to said equation error or may enter it into a log for further reference.

If the module receives information that the problem is solvable, the solver retrieves solution data (step 120). In this embodiment the solution data is a cost-optimal generation plan, and is reported to a user (step 122) concurrently with being written into Database 102 (step 124). In one embodiment the solution data may be a single cost-optimal generation plan while other, equally cost-optimal plans are either not retrieved by the module or deleted upon retrieval. Other embodiments may involve the module reporting some or all cost-optimal generation plans, at which point the user may incorporate non-cost-based considerations into the selection of a generation plan. In further embodiments, generation plans higher in cost by or below a certain (or given) percentage threshold may be reported with the optimal-cost plan. Such percentage threshold may be coded into the program or set by a user through an interface. Multiple plans may be retrieved and reported to the user as a multiple-plan list or each plan may be reported separately, allowing the user to choose to retrieve further plans only if desired.

There are several possible embodiments by which a user could incorporate non-cost-based considerations when selecting from a multitude of optimal-cost generation plans. A user may, for example, have non-cost based reasons to prefer one generation unit over a single or plurality of other generation unit(s). That user could ensure that said preferred generation unit would be selected in any solution in which said preferred generation unit was one of several other possible generation units of an optimal-cost generation plan by lowering a cost-based input (such as fuel cost) of the preferred generation unit in Database 102. In preferred embodiments said cost-based-input would be lowered by an amount large enough such that the solver preferred said generation unit over other generation units in forming an optimal-cost generation plan, but by an amount small enough such that the overall cost of the generation plan would not be materially affected. The solver would then automatically select the preferred generating unit only in situations in a generation plan using the preferred generating unit had the same or lower cost as using other generation units instead of the preferred generation unit. This functionality requires the user of the embodiment module to have read/write access to the input information in Database 102.

One further embodiment by which a user could incorporate non-cost-based considerations when selecting from a multitude of optimal-cost generation plans involves the module sorting the solution data after having been retrieved in step 120. Said embodiment would include a user interface wherein the user is able to input rules the module is to follow in sorting solution data between step 120 and steps 122 and/or 124. For example, rules may allow a user to prefer one generation unit over all others if the total-generation-plan cost utilizing said preferred generation unit were within a certain percentage of the optimal-cost generation plan not utilizing said preferred generation unit. In this way the system may force the generation unit to deliver its energy in a non-optimal generation plan. The design of such a rule-creation interface would be determined by the language in which the module was programmed and the list of Inputs 104 in Database 102, but could resemble rule-creation interfaces common in the art.

The embodiment in FIG. 1 is initiated by a user, but in other non-user-initiated embodiments the solution data could be reported in step 122 to another part of a larger program or system in which the module is integrated. Said larger program or system may contain a set of rules that determines automatic responses to said generation plan, such as an automatic increase in the output of certain energy-generating units, where applicable. In other embodiments no response may be initiated, and thus step 122 may be omitted.

Embodiments not initiated by a user could offer unique advantages. For example, one embodiment could involve a module similar to that disclosed in FIG. 1, but said module would be designed to constantly or periodically read Inputs 104 from Database 102 (step 106). When said read of Inputs 104 (step 106) detected a change in any input (or a set of preselected inputs) above a customizable or hard-coded threshold, the module would proceed to check the validity of the Inputs 104 (step 108), and, if valid, proceed through the previously discussed steps of FIG. 1 and/or related embodiments to determine whether the optimal-cost generation plan had changed since the last optimal-cost generation plan was reported. Alternatively, the module could be programmed to perform steps 106-124 periodically, regardless of any detected change in the Inputs 104. In this embodiment step 120 would be followed by an additional check comparing retrieved solution data with previously retrieved solution data stored in Database 102. Either embodiment would allow the module to alert a user or a larger program system in which the module is integrated when changed circumstances resulted in a new optimal-cost generation plan.

FIG. 2 displays a potential list of Inputs 202-240 that may be read from Database 102 in one embodiment similar to the embodiments described in relation to FIG. 1. Inputs 202-240 are collected automatically, as much as possible, by Database 102. The module automatically selects and reads any of Inputs 202-240 that are of relevance to the calculation requested of the module. Some inputs, such as Available Transmission Capacity 228, may require complex calculation using information from multiple sources, including existing transmission contracts involving or not involving the user and available transmission open for trade on public trading sources such as Open Access Same-Time Informations System (OASIS). Thus, the automatic collection, selection, and reading of Inputs 202-240 can significantly streamline the determinations the module is intended to make.

Inputs 202-240 may describe long-term and instantaneous properties of generating units, forecasted and instantaneous properties of the energy market and transmission system, and regulatory requirements of any of the above. Inputs 202-240 may take multiple forms even in the embodiment presented. For example, when reading Generation Unit Minimum Output 202 from Database 200, the module may require a minimum generation amount that is based on any or all of economic considerations, safety factors, or feasibility factors for any individual generating unit.

FIG. 3 illustrates the one set of Constraints 304-318 that may be applied to the objective function when determining a cost-optimal generation plan. In this embodiment Constraints 304-318 are written into the Code 300 of the module in the form of mathematical equations. However, in different embodiments Constraints 304-318 may be stored in any long-term or short-term memory available to the module, or may be reformulated each time the module is used. Other possible embodiments may require slightly different constraints, as different embodiments may have different inputs. Different inputs will create different objective functions, and thus different constraints may be required to set the boundaries of those objective functions. Constraints 304-318 may take multiple forms even in the present embodiment. For example, “Generation output falls between prescribed values” 306 describes the maximum and minimum values between which the power generated by any particular generation unit in a fleet must fall. Those prescribed values, as justified by long-term safety concerns, may differ from prescribed values as justified by short-term emergency concerns, and either or both may be used by the module. Similarly, most of the Constraints 304-318 may be applied for safety, business, regulatory, or other reasons. The maximum or minimum values, or both, allowed for any particular constraint may be affected by the reason for applying the constraint, and it is possible that multiple constraints may be applied on the same input for different reasons. Using “Generation output falls between prescribed values” 306 as a continuing example, the module may apply a mandatory constraint to a generation unit's output that requires that output to be below a short-term emergency maximum, and apply a second constraint to the same unit's output that measures whether the output is below long-term safety maximum. All outputs above the short-term emergency maximum would not be allowed, whereas all outputs that are above the long-term safety maximum to continue to the solution phase but flags all generation plans that require that output for review.

The order in which constraints are applied to the data is unlikely to, in most embodiments, have any effect on the solution. However, different solution programs (solvers) may calculate solutions slightly faster with the constraints applied in a certain order than in a different order. In some uses of the module, such as developing an optimal-cost generation plan with a very large fleet of generation units, this difference in calculation speed may significantly affect how feasibly the module can be used to inform generation decisions in real time. Therefore, it is desirable that the module contain functionality to alter the order in which the constraints are applied. This ability may either be implemented through a user interface or may require the order to be changed in to code of the module.

FIG. 4 illustrates an embodiment of an optional functionality, hereinafter described as a “slack” functionality, that may be activated if a solver determines that the problem presented to it is not solvable. As in the embodiment illustrated by FIG. 1, this embodiment would respond by sending an equation error to the user (step 118). At this point the user would have the option to enable the slack functionality (step 402). After slack functionality was enabled, the constraint data collected by the module and/or solver would be presented to the user. The constraint data would provide the user with information as to which constraints by which the objective function could not be bound in a cost-optimum solution. At that point the user would have the option to pursue a view a hypothetical solution based on the assumption that the objective-function solutions are within the bounds required by the constraints. This can be achieved by ordering the module to relax any applicable constraints (step 406A) or by altering the inputs of the objective function (step 406B). Relaxing the constraints (step 406A) could include either shifting the equation expressing the constraint in a direction that caused the constraint to be less restrictive to the point at which at least one solution based on the objective function (step 406A) would be included, or ignoring the constraint completely. Altering the inputs (step 406B) could affect the inputs in either an attached database or the module itself, would be performed to alter the objective function in a way that caused it to be bound within all constraints. The module would then send the equations to the solver with the slack enabled (step 408) by the user in step 406A, 406B, or both, depending on the user's preferences.

Presenting the user with hypothetical solutions using this slack functionality, in the case of calculating an optimum-cost generation plan, would provide the user with an easy method of analyzing the outcome, from a business or safety perspective, of altering the generation-plan parameters. For example, if the problem were determined to be unsolvable because the total energy generated by a generation plan was below the energy demanded for a particular time, the user could increase the total-energy-generated input parameter in step 406B, for example, by establishing purchase agreements with other energy providers, thereby causing the total-energy-generated input parameter to equal the energy-demanded parameter and view the resulting optimum-cost generation plan. In a further example, the problem may be determined to be unsolvable because all generation plans would require generation output at at least one generation unit to be above a long-term safety maximum, and the “Generation output falls between prescribed values” 306 constraint would thus be violated. The user could employ step 406A to relax this constraint, either by increasing the maximum output allowed by the constraint to the point at which at least one generation plan existed with all generation units' outputs falling within the relaxed constraint, or by instructing the module to not consider whether the generation units' outputs fell within prescribed values. Users can then make an informed decision regarding whether to purchase the energy needed to increase the total energy the appropriate amount based in part upon the desirability of the resulting solution as calculated.

The embodiment in FIG. 4 is presented as guided by a user, but in other non-user-initiated embodiments the slack functionality could be enabled automatically by the module. In such an embodiment an equation error would be returned to the module itself, which would automatically enable slack functionality and identify the constraints by which the objective function could not be bound. The module could then proceed with any combination of relaxing the constraints (step 406A) or altering the inputs (step 406B). The module would then send the equations to the solver with slack enabled. This embodiment may be advantageous in certain situations, as the module would be more capable of estimating by how much a constraint must be relaxed (step 406A) or inputs must be altered (step 406B) in order for a cost-optimal solution to be possible.

In a further embodiment allowing the pursuit of hypothetical solutions, the user may be given the functionality, independent of the equations being reported to the user as unsolvable, to alter the data or relax the constraints and pursue the resulting solutions. Such an embodiment could be enabled at any time, even before any previous equations had been sent to the solver. The embodiment would resemble the embodiment illustrated in FIG. 4, but steps 118 and 402 would not be applicable. The user would enable said functionality, and constraint data would be provided to the user, as in step 404. The user could then pursue either or both options illustrated by steps 406A and 406B, and send the hypothetical equations to the solver. Such functionality would enable the user to judge the business considerations of altering any parameters in a way that would require a change not reflected in the current database inputs or constraints.

As is presented in FIG. 5, a user may also use the module to gauge the value of producing a hypothetical amount of energy above that which the user's generation-unit fleet is already producing. The cost of generating such hypothetical amount of energy could be compared to the price at which the energy could be sold, or the price for which the user is currently purchasing or planning to purchase an equal amount of energy. In this way the user can determine whether extra energy generated could be sold for a profit, or whether extra energy could be generated for a cheaper cost than it could be purchased from another generation provider.

FIG. 5 illustrates an embodiment by which the module could calculate the generation units capable of generating additional output and the price at which that additional output must be sold or purchased in order to make said generation economically efficient. This embodiment begins with the module querying the user for a hypothetical generation amount (step 502) in addition to that which the user's generation units are already producing in the current generation plan. Upon receiving a generation amount, the module reads Inputs 104 from Database 102 (step 504) that are necessary given the properties of the generation plan. These will generally be similar to the inputs disclosed in FIG. 2. However, in some embodiments the user will also be able to insert a desired profit margin at or above which all output is to be sold. The module may then run a check to determine whether the value of the generation amount and the generation units capable of producing extra output can be calculated with the module resources and without contacting the solver (step 506). The module resources would likely be sufficient, for example, if a generation plan had just been developed by the solver and thus all Inputs 104 read from the database were current and the computed solution allowed changes without introducing violations of any of the constraints. If the solution were available without utilizing the solver, the module would present the solution to the user (step 512) and write the solution to Database 102 (step 514). If, on the other hand, the solution were not available without utilizing the solver, the module would need to send the problem to the solver to be calculated (step 508). In most embodiments this would involve sending similar constraint equations as in FIG. 1 step 114. The module would then retrieve the solution data (step 510), present the solution to the user (step 512), and write the solution to the Database 102 (step 514). In other embodiments writing the solution to Database 102 (step 514) may not occur automatically. In some such embodiments a user may be required to choose if the solution is saved, and in other embodiments the solution may not be written on Database 102, but may be sent elsewhere for storage.

In one embodiment of the above functionality, the module may present to the user only the generating unit capable of producing the entire hypothetical generation amount, in addition to the unit's current output, at the lowest cost of all capable generating units, therefore allowing the user to sell it at the highest profit or to most cost efficiently produce instead of purchase. Other embodiments may present all generating units capable of producing the entire hypothetical generation amount, in addition to the units' current output, or may present all generating units capable of producing any additional output, from which the user can compile an amount equal to the hypothetical generation amount. Alternatively, it may be desirable for the module to allow the user to set thresholds of additional output that a generating unit must be capable of producing in order to be reported to the user. For example, a user could select X megawatts, 2X megawatts, and 4X megawatts as thresholds. In such an embodiment all generating units capable of producing at least X megawatts extra output would be shown on a list next to the price above which the user must sell that X megawatts to make a profit (or, alternatively, the price below which the user must purchase that X megawatts to make purchase more cost-efficient). Such an embodiment would give the same information for all generating units capable of producing 2X megawatts and 4X megawatts. In this way a user could easily select an additional amount of output to produce, from a fleet of generating units, in order to sell for a profit or avoid purchasing where purchasing would be cost inefficient.

Some or all of the previously discussed embodiments may be performed utilizing a computer or computer system. An example of such a computer or computer system is illustrated in FIG. 6. Computer 600 contains Central Processing Unit 601. Central Processing Unit 601 may perform some or all of the processes involved in the previously discussed embodiments. Central Processing Unit 601 may utilize information contained in Memory 602, Database 603, or both. Central Processing Unit 601 may also write information to Memory 602, Database 603, or both. While in this FIG. 6 only one Computer 600 is shown, some embodiments may make use of multiple computers or computer systems. In some embodiments some of these computers or computer systems may not have dedicated memory or databases, and may utilize memory or databases that are external to the computer or computer system.

The above examples and disclosure are intended to be illustrative and not exhaustive. These examples and description will suggest many variations and alternatives to one of ordinary skill in this art. All of these alternatives and variations are intended to be included within the scope of the claims, where the term “comprising” means “including, but not limited to”. Those familiar with the art may recognize other equivalents to the specific embodiments described herein which equivalents are also intended to be encompassed by the claims. Further, the particular features presented in the dependent claims can be combined with each other in other manners within the scope of the invention such that the invention should be recognized as also specifically directed to other embodiments having any other possible combination of the features of the dependent claims. For instance, for purposes of written description, any dependent claim which follows should be taken as alternatively written in a multiple dependent form from all claims which possess all antecedents referenced in such dependent claim.

1. A method for determining a profit-maximizing plan comprising the steps of:
incorporating a plurality of inputs relating to a plurality of parameters of the plan to be maximized;
incorporating one or more constraints to limit the profit-maximizing plan based on said plurality of inputs;
testing all possible combinations of said plurality of inputs, within said one or more constraints, to develop one or more profit-maximizing plans using a computer program;
selecting one of the one or more profit-maximizing plans.

2. The method of claim 1, wherein said profit-maximizing plan comprises a plan to maximize the profit of energy generation.

3. The method of claim 1, wherein said profit-maximizing plan is determined by minimizing plan costs.

4. The method of claim 1, wherein said plurality of inputs comprise long-term and instantaneous properties of generating units, forecasted and instantaneous properties of the energy market and transmission system, and regulatory requirements.

5. The inputs of claim 4, wherein said properties of the energy market and transmission system comprise available transmission open for trade on public trading sources.

6. The method of claim 1, wherein said list of profit-maximizing plans includes some non-profit-maximizing plans for non-cost-based considerations.

7. The method of claim 6, wherein said inclusion of non-profit-maximizing plans is based on a predetermined percentage threshold.

8. The method of claim 1, wherein said one or more profit-maximizing plans eliminates at least one plan or includes at least one non-profit-maximizing plan based on previously established, non-cost based rules.

9. The method of claim 1, wherein said method includes functionality to customize said inputs.

10. The method of claim 1, wherein said method includes functionality to relax said constraints.

11. The method of claim 1, wherein said method is rerun periodically based on the passage of a predetermined amount of time.

12. The method of claim 1, wherein said method is rerun at the occurrence of a predetermined event.

13. A method of determining a profit-maximizing energy-generation plan comprising:
determining an amount of additional generation above currently considered plans, and developing a list of generation units capable of contributing to said additional generation.

14. The method of claim 13 wherein said list of generation units capable of contributing to said additional generation comprises only generation units capable of producing additional generation in predetermined amounts.

15. The method of claim 13 wherein said list of generating units capable of contributing to said additional generation comprises only generating units capable of generating energy above a predetermined profit margin.

16. The method of claim 13, wherein said method includes reporting the price at which each generation unit must sell additional generation to be profitable.

17. The method of claim 16, wherein said prices reflect a predetermined minimum profit margin.

18. The method of claim 13, wherein said method includes reporting the price at or below which purchasing energy would be more economical than generating said additional generation at each generation unit.

19. A system for determining a profit-maximizing plan comprising:
a computer having a memory and a computer program running in the memory, the computer program configured to:
incorporate a plurality of inputs relating to a plurality of parameters of the plan to be maximized;
incorporate one or more constraints to limit the profit-maximizing plan based on said plurality of inputs;
test all possible combinations of said plurality of inputs, within said one or more constraints, to develop one or more profit-maximizing plans using a computer program;
select one of the one or more profit-maximizing plans.

20. The system of claim 19, wherein said profit-maximizing plan comprises a plan to maximize the profit of energy generation.

21. The system of claim 19, wherein said profit-maximizing plan is determined by minimizing plan costs.

22. The system of claim 19, wherein said plurality of inputs comprise long-term and instantaneous properties of generating units, forecasted and instantaneous properties of the energy market and transmission system, and regulatory requirements.

23. The inputs of claim 22, wherein said properties of the energy market and transmission system comprise available transmission open for trade on public trading sources.

24. The system of claim 19, wherein said list of profit-maximizing plans includes some non-profit-maximizing plans for non-cost-based considerations.

25. The system of claim 24, wherein said inclusion of non-profit-maximizing plans is based on a predetermined percentage threshold.

26. The system of claim 19, wherein said one or more profit-maximizing plans eliminates at least one plan or includes at least one non-profit-maximizing plan based on previously established, non-cost based rules.

27. The system of claim 19, wherein said system includes functionality to customize said inputs.

28. The system of claim 19, wherein said system includes functionality to relax said constraints.

29. The system of claim 19, wherein said system is rerun periodically based on the passage of a predetermined amount of time.

30. The system of claim 19, wherein said system is rerun at the occurrence of a predetermined event.

31. A system of determining a profit-maximizing energy-generation plan comprising:
a computer having a memory and a computer program running in the memory, the computer program configured to:
determine an amount of additional generation above currently considered plans, and
develop a list of generation units capable of contributing to said additional generation.

32. The system of claim 31 wherein said list of generation units capable of contributing to said additional generation comprises only generation units capable of producing additional generation in predetermined amounts.

33. The system of claim 31 wherein said list of generating units capable of contributing to said additional generation comprises only generating units capable of generating energy above a predetermined profit margin.

34. The system of claim 31, wherein said system includes reporting the price at which each generation unit must sell additional generation to be profitable.

35. The system of claim 34, wherein said prices reflect a predetermined minimum profit margin.

36. The system of claim 31, wherein said system includes reporting the price at or below which purchasing energy would be more economical than generating said additional generation at each generation unit.
